(19) United States
(12) Patent Application Publication
(10) Pub. No.: US 2006/0012988 A1
(43) Pub. Date: Jan. 19, 2006

(54) FINE-TUNABLE MIXING LIGHT FOR LIGHT EMITTING DIODE

(76) Inventors: Hsiang-Cheng Hsieh, Tao-Yuan Hsien (TW); Teng-Huei Huang, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 10/710,265

(22) Filed: Jun. 30, 2004

(51) Int. Cl. F21V 9/00

(52) U.S. Cl. 362/231

(57) ABSTRACT

A fine-tunable RGB mixing LED has a red LED unit electrically connected to a first embedded variable resistor, a green LED unit electrically connected to a second embedded variable resistor, and a blue LED unit electrically connected to a third embedded variable resistor. The spectrum of the RGB mixing LED can be fine-tuned using a laser to trim the first, second and/or third embedded variable resistors.

### BACKGROUND OF INVENTION

1. Field of the Invention

The invention relates to a RGB mixing light emitting diode (LED), and more particularly, to a fine-tunable RGB mixing LED.

2. Description of the Prior Art

A light emitting diode (LED) is a semiconductor device with a long lifetime and a high efficiency in transforming electricity into light. Since the LED is a small light source and can be applied to many kinds of portable equipment, the LED will take the place of tungsten lamp and mercury lamp to be a popular light source in the future. The LED has advantages of long lifetime, small size, high shock resistance, less heat, and low power consumption, so the LED is widely used in electric appliances and equipment as an indicator or a light source. In recent years, the LED has developed toward multicolor and high brightness levels, and can be applied in outdoor bulletin boards or traffic signals. The LED can take the place of tungsten lamp and mercury lamp to be a power saving and environmentally protecting light source.

The fabrication method of a white light LED can be generally divided into three types: the first one is a blue light LED with added yellow fluorescent phosphor, the second one is a RGB mixing LED using red, green and blue LED units, and the third one is an ultraviolet chip with added RGB fluorescent phosphor. Please refer to FIG. 1, which is a simple schematic diagram of an RGB mixing LED 10 connected with an external circuit according to the prior art. The RGB mixing LED 10 includes a red LED unit 12, a green LED unit 14, and a blue LED unit 16, and external resistors 18, 20, and 22 that are separately connected to each LED unit. The conventional fabrication method is measuring the optic-electrics characteristics of the red, green, and blue LED units 12, 14, 16 after finishing manufacturing the RGB mixing LED 10. Then, the three external resistors 18, 20, 22 are utilized to control the currents of the red, green, and blue LED units 12, 14, 16 to fulfill brightness and chroma requirements.

Since the optic-electrics characteristics of the red, green, and blue LED units 12, 14, 16 are very complex, different RGB mixing LEDs 10 with equivalent external resistors 18, 20, 22 will have problems of irregular brightness or chroma. If the RGB mixing LEDs 10 are sorted after measuring the optic-electrics characteristics of the red, green, and blue LED units 12, 14, 16 and are collocated with different external resistors 18, 20, 22, many sets of the external resistors 18, 20, 22 are required and many extra sorting procedures will be added.

### SUMMARY OF INVENTION

It is therefore a primary objective of the claimed invention to provide a fine-tunable RGB mixing LED that can be manufactured in LED units with identical standards and adjust the resistance of the embedded variable resistors after measuring the optic-electrics characteristics.

According to the claimed invention, a fine-tunable RGB mixing light emitting diode has a red LED unit electrically connected to a first embedded variable resistor, a green LED unit electrically connected to a second embedded variable resistor, and a blue LED unit electrically connected to a third embedded variable resistor. The spectrum of the RGB mixing LED can be fine-tuned by adjusting the resistance of the first, second, and third embedded variable resistors by laser-trimming.

According to the claimed invention, an RGB mixing light emitting diode has a red LED unit electrically connected to a first embedded variable passive component, a green LED unit electrically connected to a second embedded variable passive component, and a blue LED unit electrically connected to a third embedded variable passive component. The spectrum of the RGB mixing LED can be fine-tuned by adjusting the resistance of the first, second, and third embedded variable passive component.

These and other objectives of the present invention will no doubt become obvious to those of ordinary skill in the art after reading the following detailed description of the preferred embodiment that is illustrated in the various figured and drawings.

### BRIEF DESCRIPTION OF DRAWINGS

FIG. 1 is a schematic diagram of an RGB mixing light emitting diode connected to the external circuit according to the prior art.

FIG. 2 is a schematic diagram of an RGB mixing light emitting diode connected to the external circuit according to the present invention.

FIGS. 3-9 are schematic diagrams of the manufacturing procedure of an LED unit and an embedded variable resistor in an RGB mixing LED according to the present invention.

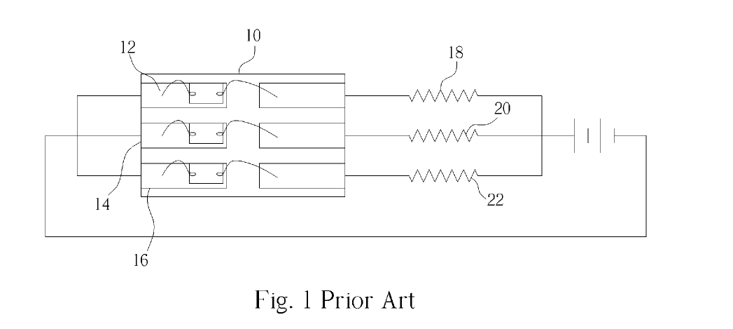

### DETAILED DESCRIPTION

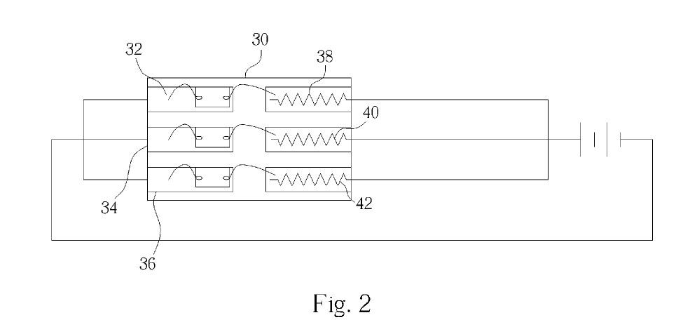

Please refer to FIG. 2, which is a schematic diagram of a preferred embodiment according to the present invention. An RGB mixing LED 30 includes a red LED unit 32, a green LED unit 34, and a blue LED unit 36 respectively connected to a first embedded variable resistor 38, a second embedded variable resistor 40 and a third embedded variable resistor 42. The first, second, and third embedded variable resistors 38, 40, 42 are printed resistors or thinfilm resistors, and are deposited on a same substrate as the red, green, and blue LED units 32, 34, 36.

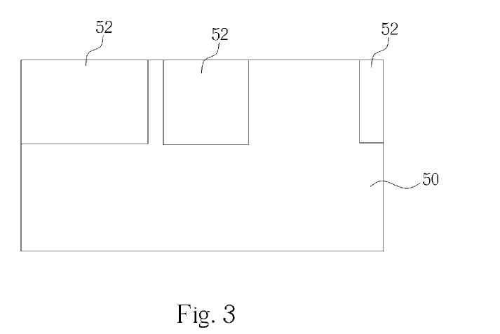

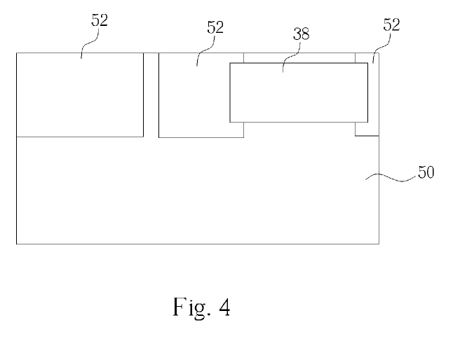

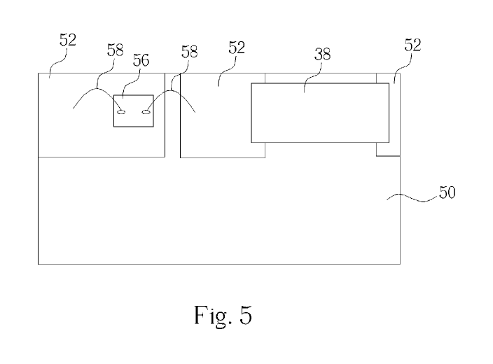

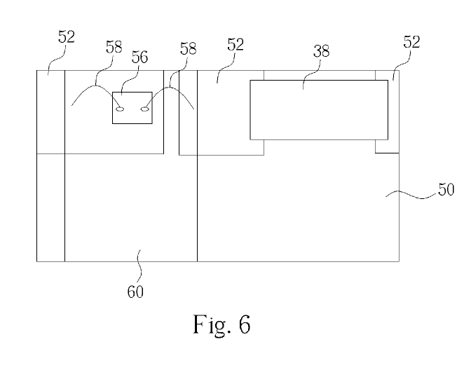

Please refer to FIGS. 3 to 9, which, using the red LED unit 32 and the first embedded variable resistor 38, explain the manufacturing procedure of the RGB mixing LED 30. The manufacturing procedure of the other two LED units 34, 36 and the corresponding embedded variable resistors 40, 42 are similar. Firstly, as shown in FIG. 3, a conductive film 52 is formed on the substrate 50 in a predetermined pattern to be a conduction path for the whole RGB mixing LED. FIG. 4 shows an embedded variable resistor 38 formed on the substrate 50. Both ends of the embedded variable resistor 38 are electrically connected to the conductive film 52, and the embedded variable resistor 38 can be a thin-film resistor formed by using a thin film process or a printed resistor formed by using a printing process. Then, as shown in FIG. 5, an LED chip 56 is posited on the conductive film 52 and a wire 58 connecting the LED chip 56 and the conductive film 52 is manufactured. FIG. 6 shows a protection layer 60 covering the LED chip 56 and the wire 58 to fix and protect the wire 58. At this time, the conductive film 52, the LED chip 56, the wire 58, and the embedded variable resistor 38 comprise a complete fine-tunable LED unit circuit.

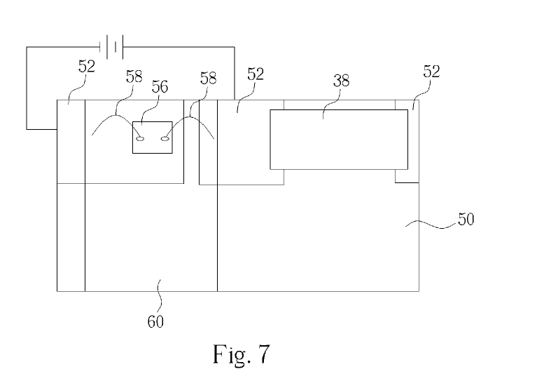

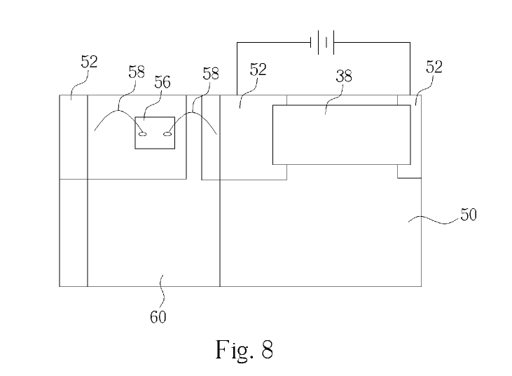

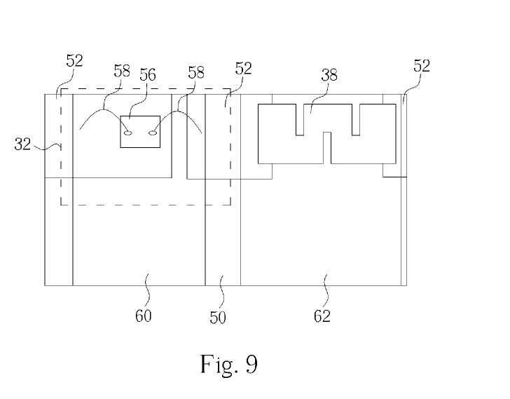

Please refer to FIGS. 7 and 8. After finishing a fine-tunable LED unit circuit, both ends of the LED chip 56 are connected to a power source via the conductive film 52 and the wire 58 to measure its optic-electrics characteristics. According to the required colors, such as white light or colored light, the current flowing through the LED chip 56 is calculated and the corresponding resistance of the embedded variable resistor 38 is defined. Finally, as shown in FIG. 9, the embedded variable resistor 38 is trimmed by a laser to increase the resistance, and a protection layer 62 is formed to cover the embedded variable resistor 38.

The embedded variable resistors are used to explain the present invention in the preferred embodiment, but other embedded variable passive components, such as an embedded variable capacitor or an embedded variable inductor, are also suitable for the present invention. Even other embedded variable active components can be also applied to the present invention, such as any type of diode or a metal oxide semiconductor connected to the LED chip in series or parallel to control the current. The present invention utilizes the embedded variable passive component to fabricate the RGB mixing LED with identical standards and then adjusts the current flowing through each LED unit after measuring the optic-electrics characteristics. Any type of the embedded variable passive component that can adjust the current value can be applied to the present invention.

In contrast to the prior art, the present invention has the features of identical fabrication standards and matching multicolor requirements, lowering manufacturing costs.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A fine-tunable RGB mixing light emitting diode (LED) comprising:
a red LED unit electrically connected to a first embedded variable resistor;
a green LED unit electrically connected to a second embedded variable resistor; and
a blue LED unit electrically connected to a third embedded variable resistor;
wherein spectrum of the RGB mixing LED can be fine-tuned by adjusting resistance of the first, second, and third embedded variable resistors by laser-trimming.

2. The RGB mixing LED of claim 1, wherein the first, second, and third embedded variable resistors comprise printed resistors or thin-film resistors.

3. The RGB mixing LED of claim 1, wherein resistance of the first, second, and third embedded variable resistors is adjusted by laser trimming the first, second, and/or third embedded variable resistors.

4. A RGB mixing light emitting diode (LED) comprising:
a red LED unit electrically connected to a first embedded variable passive component;
a green LED unit electrically connected to a second embedded variable passive component; and
a blue LED unit electrically connected to a third embedded variable passive component;
wherein spectrum of the RGB mixing LED can be fine-tuned by adjusting resistance of the first, second, and third embedded variable passive components.

5. The RGB mixing LED of claim 4, wherein the first, second, and third embedded variable passive components comprise an embedded variable resistor, an embedded variable capacitor, or an embedded variable inductor.

6. The RGB mixing LED of claim 5, wherein the embedded variable resistor comprises a printed resistor or thin-film resistor.

7. The RGB mixing LED of claim 4, wherein spectrum of the RGB mixing LED is fine-tuned with laser-trimming the first, second, and/or third embedded variable passive components.

8. A light emitting diode (LED), comprising:
a LED unit; and
an embedded variable electric device electrically connected to the LED unit;
wherein, brightness of the LED can be fine-tuned by adjusting the embedded variable electric device.

9. The LED of claim 8, wherein a plurality of LED units and a plurality of corresponding embedded variable electric devices can be further connected to constitute the LED in parallel or in series.

10. The LED of claim 9, wherein the LED units radiate light of different colors.

11. The LED of claim 8, wherein the embedded variable electric device is an embedded variable passive component.

12. The LED of claim 11, wherein the embedded variable passive component comprises an embedded variable resistor, an embedded variable capacitor, or an embedded variable inductor.

13. The LED of claim 12, wherein the embedded variable resistor comprises a printed resistor or a thin-film resistor.

14. The LED of claim 8, wherein the embedded variable electric device is an embedded variable active component.

15. The LED of claim 14, wherein the embedded variable active component comprises a diode or a metal oxide semiconductor (MOS), and the embedded variable active component connects with the LED unit in series or parallel.

16. The LED of claim 8, wherein brightness of the LED can be fine-tuned with laser-trimming the embedded variable electric device.
